(19) United States
(12) Patent Application Publication
(10) Pub. No.: US 2014/0180533 A1
(43) Pub. Date: Jun. 26, 2014

(54) MOTOR VEHICLE REVERSE COUNTER AND DISPLAY DEVICE

(71) Applicants: William Jerry Bowman, Provo, UT (US); Gustaf Eric Bowman, Twin Falls, ID (US)

(72) Inventors: William Jerry Bowman, Provo, UT (US); Gustaf Eric Bowman, Twin Falls, ID (US)

(21) Appl. No.: 14/062,730

(22) Filed: Oct. 24, 2013

Related U.S. Application Data
(60) Provisional application No. 61/727,697, filed on Nov. 17, 2012.

(51) Int. Cl. G06M 3/00

(52) U.S. Cl. CPC G06M 3/00
USPC 701/33.4

(57) ABSTRACT

An apparatus for reducing accidents and/or insurance rates for motor vehicles may include a connection device for connecting to a reverse gear signal corresponding to a backup light, and a recording device for monitoring the reverse gear signal provided by the connection device. The recording device may also record reverse gear occurrence information corresponding to changes in the reverse gear signal. The apparatus may be incorporated into a vehicle and record reverse gear occurrence information corresponding to occurrences of a driver placing a vehicle in a reverse gear. A corresponding method is also disclosed herein.

### REFERENCE TO RELATED APPLICATIONS

This application claims the benefit of U.S. Provisional Patent Application No. 61/727,697 entitled “MOTOR VEHICLE REVERSE COUNTER AND DISPLAY DEVICE” and filed on 17 Nov. 2012. The aforementioned application is incorporated herein by reference in its entirety.

### BACKGROUND OF THE INVENTION

1. Field of the Invention

The claimed invention relates to driver monitoring systems, apparatii and methods in general, and to reverse gear usage monitoring systems, apparatii and methods in particular.

2. Background

An estimated 90% of commercial vehicle accidents occur while driving in reverse. What is needed are means and methods to monitor and log occurrences of operating a vehicle in reverse and thereby provide information useful for route selection, determining insurance rates, instructing drivers, modifying driving habits, and reducing accident rates.

### BRIEF SUMMARY OF THE INVENTION

The present invention has been developed in response to the present state of the art, and in particular, in response to the problems and needs in the art that have not yet been fully solved by currently available driver monitoring systems, apparatii and methods. Accordingly, the claimed inventions have been developed to provide a reverse gear monitoring system, apparatus and method that overcomes shortcomings in the art.

As detailed below, a system for reducing accidents and/or insurance rates for motor vehicles may include a vehicle equipped with a reverse gear monitor, the reverse gear monitor configured to record reverse gear occurrence information corresponding to occurrences of a driver placing a vehicle in a reverse gear, and a data retrieval device configured to retrieve the occurrence information from the reverse gear monitor.

A corresponding apparatus for reducing accidents and/or insurance rates for motor vehicles may include a connection device for connecting to a reverse gear signal corresponding to a backup light, and a recording device for monitoring the reverse gear signal provided by the connection device and recording reverse gear occurrence information corresponding to changes in the reverse gear signal.

A corresponding method for reducing accidents and/or insurance rates for motor vehicles may include providing a reverse gear monitor for a vehicle, recording reverse gear occurrence information with the reverse gear monitor, the reverse gear occurrence information corresponding to occurrences of a driver placing a vehicle in a reverse gear, and obtaining the occurrence information from the reverse gear monitor.

The described system, apparatus and method can reduce the number of accidents caused from operating motor vehicles in reverse. In one embodiment, the number of times that a motor vehicle is driven in reverse is detected and displayed to provide feedback to a driver and train the driver to use reverse less often. The described system, apparatus and method also enable fleet managers to evaluate and compare the tendency of different drivers to drive in reverse.

A variety of embodiments of the aforementioned system, apparatus and method are disclosed herein. It should be noted that references throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram of one example of an accident reduction system that is consistent with one or more embodiments of the claimed invention;

FIG. 2 is a block diagram of one example of an accident reduction apparatus that is consistent with one or more embodiments of the claimed invention;

FIG. 3 is a block diagram of one example of a recording device that is consistent with one or more embodiments of the claimed invention; and

FIG. 4 is a flowchart diagram of one example of an accident reduction method that is consistent with one or more embodiments of the claimed invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any form capable of enabling execution of a program of machine-readable instructions on a digital processing apparatus. For example, a computer readable medium may be embodied by a flash drive, compact disk, digital-video disk, a magnetic tape, a Bernoulli drive, a magnetic disk, a punch card, flash memory, integrated circuits, or other digital processing apparatus memory device. A digital processing apparatus such as a computer may store program codes, associated data, and the like on the computer readable medium that when retrieved enable the digital processing apparatus to execute the functionality specified.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

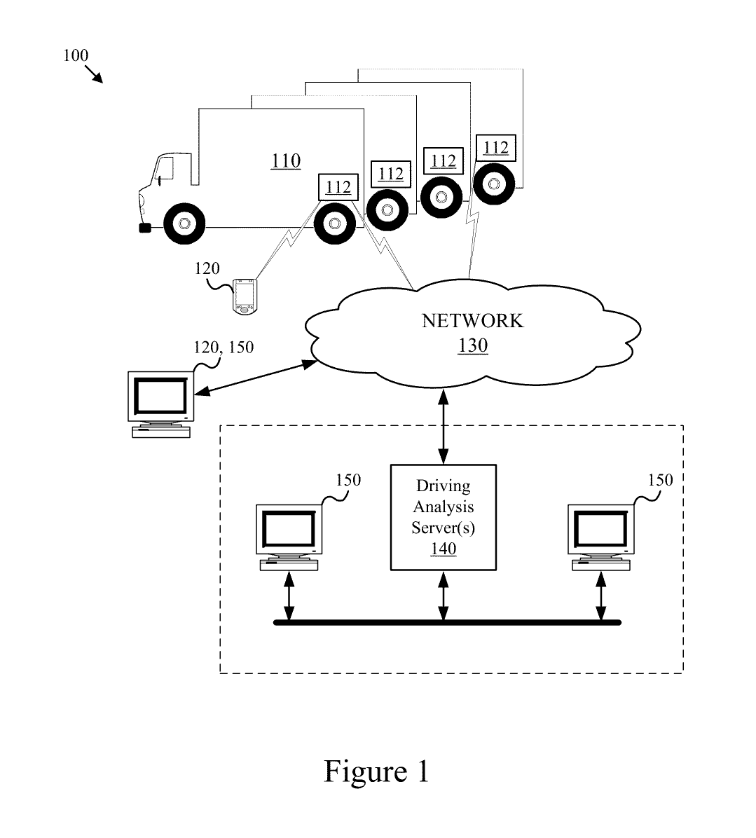

FIG. 1 is a block diagram of one example of an accident reduction system 100 that is consistent with one or more embodiments of the claimed invention. As depicted, the accident reduction system 100 includes one or more vehicles 110 equipped with a reverse gear monitor 112, a data retrieval device 120, a network 130, a driving analysis server 140, and a driving analysis workstation 150.

The data retrieval device 120 facilitates obtaining reverse gear occurrence information, corresponding to occurrences of a driver placing a vehicle in a reverse gear, from the reverse gear monitors 112 within the vehicles 110. The data retrieval device 120 may be connected directly to a reverse gear monitor via an access port or communicate via a network such as the network 130. In the depicted embodiment, the network 130 includes one or more wireless routers (not shown) that enable wireless access to the reverse gear monitors 112.

The driving analysis server 140 may include a storage device or control access to a storage device (not shown) that is used to store the reverse gear occurrence information. The reverse gear occurrence information may include an incident count, location information, time information and the like. The data retrieval device 120 may provide the reverse gear occurrence information retrieved from the vehicles 110 to the driving analysis server 140 for permanent or semi-permanent storage.

The driving analysis workstation 150 and/or the data retrieval device 120 may be equipped with software that facilitates analysis of the reverse gear occurrence information and thereby provides a driving analysis tool to various stakeholders such as drivers, managers, insurance companies, and the like. For example, the driving analysis tool may enable comparison of the driving habits of various drivers. Various routes may be analyzed for the occurrence of driving in reverse. By facilitating such analysis and feedback, the accident reduction system 100 may reduce accident rates and/or insurance rates.

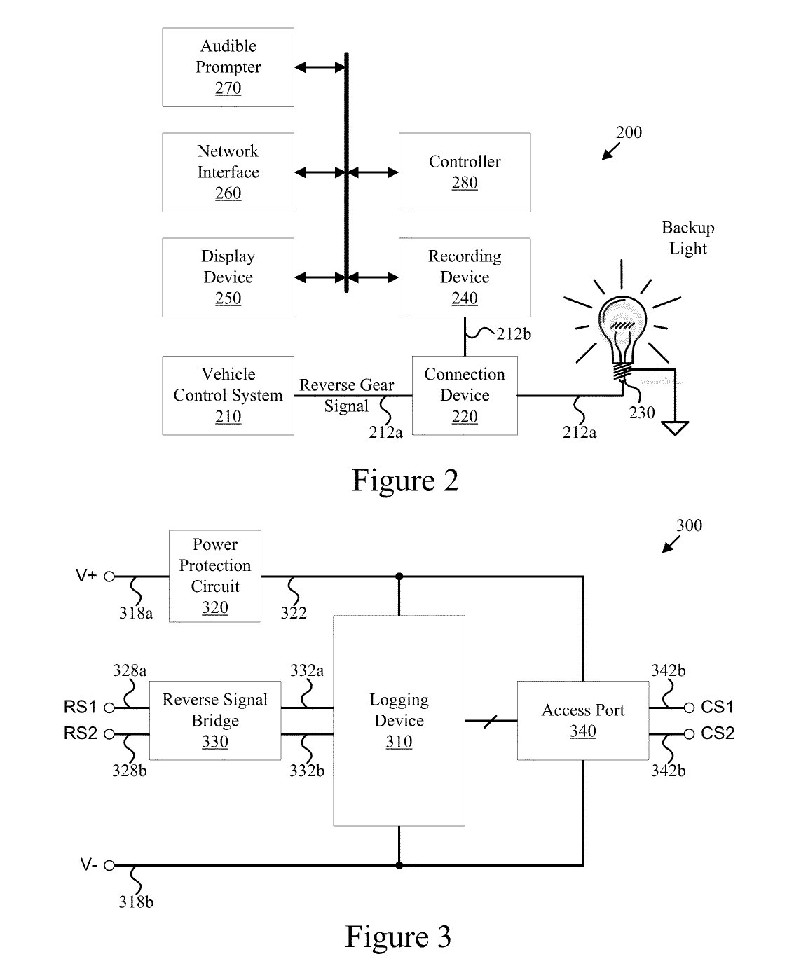

FIG. 2 is a block diagram of one example of an accident reduction apparatus 200 that is consistent with one or more embodiments of the claimed invention. As depicted, the accident reduction apparatus 200 includes a vehicle control system 210, a connection device 220, a backup indicator 230, a recording device 240, a display device 250, a network interface 260, an audible prompter 270, and a controller 280. The accident reduction apparatus 200 is one example of the reverse gear monitor 112 shown in FIG. 1. The accident reduction apparatus 200 may be installed in a factory when a vehicle is manufactured, at a dealership or as an aftermarket device.

The vehicle control system 210 or a subsystem thereof may provide a reverse gear signal 212a to the backup indicator 230 when a driver places a vehicle in reverse. The connection device 220 may be attached to, or installed in-line with, a wire or trace that bears the reverse gear signal 212a to the backup indicator 230. Consequently, the connection device 220 may provide a reverse gear signal 212b to the recording device 240 that is identical to, or similar to, the reverse gear signal 212a. In one embodiment, the connection device 220 is an in-line connector.

The recording device 240 may record occurrences of when the reverse gear signal 212 is activated. For example, the recording device may increment an incident count when a transition or change is detected in the reverse gear signal 212 that corresponds to driving in reverse. The recording device may be configured to ignore occurrences that are shorter than a particular duration. In one embodiment, the particular duration is selectable. In some embodiments, time and location information for each incident is also recorded by the recording device 240.

The display device 250 may display the reverse gear occurrence information, or a portion thereof, to a driver to provide feedback on reverse gear driving habits. The network interface 260 may facilitate retrieval of the reverse gear occurrence information. In one embodiment, the recording device 240 may be cleared or reset via the network interface 260. In another embodiment, a reset button (not shown) is used to reset the recording device 240.

The audible prompter 270 may provide an audible prompt to a user to initiate an action such as rolling down a window and/or checking the rear view minors. In one embodiment, that audible prompter comprises a speaker, a non-volatile memory with one or more (digitized) audible prompts stored therein, and an audio driving circuit for converting the digitized audible prompts to a driving signal for the speaker. The controller 280 may be a CPU, a microcontroller, a programmable logic device, or the like, that is configured to execute instructions that control the sequencing and timing of tasks performed by the various modules of the accident reduction apparatus 200.

FIG. 3 is a block diagram of one example of a recording device 300 that is consistent with one or more embodiments of the claimed invention. As depicted, the recording device 300 includes a logging device 310, a power protection circuit 320, a reverse signal bridge 330, and an access port 340. The recording device 300 is one example of the recording device 240 that is integrated into the apparatus 200. The recording device 300 may also operate independently as the reverse gear monitor 112.

The logging device 310 logs occurrences of a vehicle operating in a reverse gear. In one embodiment, the logging device comprises a counter. In some embodiments, the logging device includes non-volatile memory such as Flash memory for storing reverse gear occurrence information. The logging device 310 may also include logic and/or timing circuitry that enables the logging device 310 to ignore reverse gear occurrences that are shorter than a selected duration.

The power protection circuit 320 protects the recording device 300 from improper installation and power surges. For example, when the power inputs 318a and 318b are improperly reversed, the power protection may block current flow to the logging device 310 and thereby protect the logging device 310 and the access port 340. The reverse signal bridge 330 may be a bridge circuit that enables the recording device 300 to operate regardless of the polarity of the reverse signal inputs 328a and 328b. The access port 340 may enable access to the contents of the logging device 310. In one embodiment, the access port 340 is a UART.

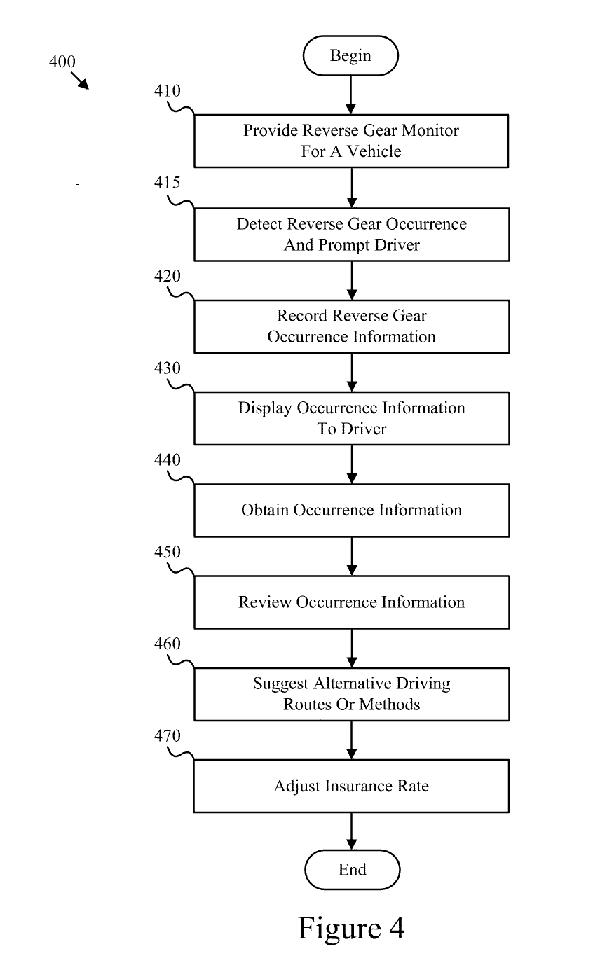

FIG. 4 is a flowchart diagram of one example of an accident reduction method 400 that is consistent with one or more embodiments of the claimed invention. As depicted, the accident reduction method 400 includes providing (410) a reverse gear monitor for a vehicle, detecting (415) a reverse gear occurrence, recording (420) reverse gear occurrence information, displaying (430) the occurrence information to a driver, obtaining (440) the occurrence information, reviewing (450) the occurrence information, suggesting (460) alternative driving routes or methods, and adjusting (470) an insurance rate. The method 400 may be conducted in conjunction with the reverse gear monitor 112 or the like.

Providing (410) a reverse gear monitor for a vehicle may include obtaining and installing a reverse gear monitor 112 (e.g. the apparatus 200 or the device 300) in a vehicle. For example, providing (410) could include purchasing a monitor 112 and electrically connecting the monitor 112 to a vehicle battery for power and to a backup light or a corresponding electrical signal to enable use of the monitor 112.

Detecting (415) a reverse gear occurrence may include monitoring a backup light signal for a transition that corresponds to activating a backup light. In response to detecting the reverse gear occurrence, the driver may be prompted to initiate one of more actions such as rolling down the windows to increase the ability to hear local sounds and checking one or more rear view mirrors for obstructions.

Recording (420) reverse gear occurrence information may include using the reverse gear monitor 112, or the like, to record occurrences of a vehicle operating in reverse. For example, the monitor 112 may detect and record transitions in a reverse gear signal that drives a backup light such as the backup light 230. Displaying 430 the occurrence information to a driver may include providing a display within or attached to the vehicle that can be readily viewed by the driver.

Obtaining (440) the occurrence information may include using the data retrieval device to retrieve the reverse gear occurrence information from the reverse gear monitor 112 or the like. Alternately, the reverse gear monitor 112 may sense when reverse gear occurrence information and the network 130 are available and push the reverse gear occurrence information to the driving analysis server 140.

Reviewing (450) the occurrence information may include using the driving analysis workstation 150 and/or the data retrieval device 120 to review and/or analyze the reverse gear occurrence information. Suggesting (460) alternative driving routes or methods may include automatically or manually creating driving routes or methods that avoid the need to operate in reverse. Adjusting (470) an insurance rate may include factoring the reverse gear occurrence information in estimating or calculating an insurance rate.

The proceeding depiction of the claimed invention is intended to be illustrative rather than definitive. Similarly, the claimed invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for reducing accidents and/or insurance rates for motor vehicles, the apparatus comprising:
a connection device for connecting to a reverse gear signal corresponding to a backup light; and
a recording device for monitoring the reverse gear signal provided by the connection device and recording reverse gear occurrence information corresponding to changes in the reverse gear signal.

2. The apparatus of claim 1, wherein the recording device is configured to detect edge transitions in the reverse gear signal.

3. The apparatus of claim 1, wherein the recording device comprises a counter.

4. The apparatus of claim 1, wherein the recording device has a reset feature for clearing the counter.

5. The apparatus of claim 1, wherein the recording device has a reset feature for clearing the occurrence information.

6. The apparatus of claim 1, wherein the reverse gear occurrence information comprises an incident count.

7. The apparatus of claim 1, wherein the reverse gear occurrence information consists of an incident count.

8. The apparatus of claim 1, further comprising a display for displaying the reverse gear occurrence information, or a portion thereof, to a driver.

9. The apparatus of claim 1, further comprising an audio feedback device for prompting a user to roll down at least one window.

10. A system for reducing accidents and/or insurance rates for motor vehicles, the system comprising:
a vehicle equipped with a reverse gear monitor, the reverse gear monitor configured to record reverse gear occurrence information corresponding to occurrences of a driver placing a vehicle in a reverse gear; and
a data retrieval device configured to retrieve the occurrence information from the reverse gear monitor.

11. The system of claim 10, wherein the reverse gear monitor is electrically connected to a backup light or a corresponding electrical signal of the vehicle.

12. The system of claim 10, wherein the reverse gear occurrence information comprises an incident count.

13. The system of claim 10, wherein the reverse gear occurrence information comprises location information or time information.

14. The system of claim 10, wherein the vehicle is further equipped with a display for displaying the reverse gear occurrence information or a portion thereof to a driver.

15. The system of claim 10, wherein the vehicle is further equipped with an audible prompter for prompting a user to roll down a window.

16. The system of claim 15, wherein the user is prompted to roll down the window in response to the driver placing the vehicle in the reverse gear.

17. A method for reducing accidents and/or insurance rates for motor vehicles, the method comprising:
providing a reverse gear monitor for a vehicle;
recording reverse gear occurrence information with the reverse gear monitor, the reverse gear occurrence information corresponding to occurrences of a driver placing a vehicle in a reverse gear; and
obtaining the occurrence information from the reverse gear monitor.

18. The method of claim 17, wherein the reverse gear occurrence information comprises an incident count.

19. The method of claim 17, further comprising displaying the reverse gear occurrence information or a portion thereof to the driver.

20. The method of claim 17, further comprising reviewing the occurrence information.

21. The method of claim 17, wherein the user is prompted to roll down a window in response to the driver placing the vehicle in the reverse gear.
